(19) United States
(12) Patent Application Publication
(10) Pub. No.: US 2025/0159667 A1
(43) Pub. Date: May 15, 2025

(54) TECHNIQUES FOR CONFIGURING TIMING ADVANCE GROUPS FOR COMPONENT CARRIERS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Fang YUAN, Beijing (CN); Yan ZHOU, San Diego, CA (US); Tao LUO, San Diego, CA (US)

(21) Appl. No.: 18/839,906

(22) PCT Filed: Apr. 29, 2022
(86) PCT No.: PCT/CN2022/090300

§ 371 Date: Aug. 20, 2024

(51) Int. Cl. H04W 72/0453; H04L 5/00; H04W 56/00; H04W 72/51

(52) U.S. Cl. CPC H04W 72/0453; H04L 5/001; H04W 56/0045; H04W 72/51

(57) ABSTRACT

Various aspects of the present disclosure generally relate to wireless communication. In some aspects, a user equipment (UE) may receive configuration information indicating: a first configuration of multiple control resource set (CORESET) pool indexes for a first component carrier and for a second component carrier, and a second configuration of a first set of multiple timing advance groups (TAGs) for the first component carrier and a second set of one or more TAGS for the second component carrier, wherein the second set of one or more TAGs is configured based at least in part the first set of multiple TAGs. The UE may transmit one or more communications via the first component carrier and the second component carrier based at least in part the first set of multiple TAGs and the second set of one or more TAGS. Numerous other aspects are described.

### FIELD OF THE DISCLOSURE

Aspects of the present disclosure generally relate to wireless communication and to techniques and apparatuses for techniques for configuring timing advance groups for component carriers.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information indicating, a first configuration of multiple control resource set (CORESET) pool indexes for a first component carrier and for a second component carrier, and a second configuration of a first set of multiple timing advance groups (TAGs) for the first component carrier and a second set of one or more TAGS for the second component carrier, where the second set of one or more TAGs is configured based at least in part the first set of multiple TAGs. The method may include transmitting one or more communications via the first component carrier and the second component carrier based at least in part the first set of multiple TAGs and the second set of one or more TAGS.

Some aspects described herein relate to a method of wireless communication performed by a UE. The method may include transmitting an indication of a capability to communicate with multiple timing advances (TAs) for a single component carrier. The method may include receiving configuration information indicating, multiple CORESET pool indexes for communication within the single component carrier, and one or more TAGS for the single component carrier based at least in part on the capability.

Some aspects described herein relate to a method of wireless communication performed by a network node. The method may include transmitting configuration information indicating, a first configuration of multiple CORESET pool indexes for a first component carrier and for a second component carrier, and a second configuration of a first set of multiple TAGs for the first component carrier and a second set of one or more TAGS for the second component carrier, where the second set of one or more TAGs is configured based at least in part the first set of multiple TAGs. The method may include receiving one or more communications via the first component carrier and the second component carrier based at least in part the first set of multiple TAGs and the second set of one or more TAGS.

Some aspects described herein relate to a method of wireless communication performed by a network node. The method may include receiving an indication of a capability to communicate with multiple TAs for a single component carrier. The method may include transmitting configuration information indicating, multiple CORESET pool indexes for communication within the single component carrier, and one or more TAGS for the single component carrier based at least in part on the capability.

Some aspects described herein relate to a UE for wireless communication. The user equipment may include a memory and one or more processors coupled to the memory. The one or more processors may be configured to receive configuration information indicating. The one or more processors may be configured to transmit one or more communications via the first component carrier and the second component carrier based at least in part the first set of multiple TAGs and the second set of one or more TAGS.

Some aspects described herein relate to a UE for wireless communication. The UE may include a memory and one or more processors coupled to the memory. The one or more processors may be configured to transmit an indication of a capability to communicate with multiple TAs for a single component carrier. The one or more processors may be configured to receive configuration information indicating multiple CORESET pool indexes for communication within the single component carrier, and one or more TAG) for the single component carrier based at least in part on the capability.

Some aspects described herein relate to a network node for wireless communication. The network node may include a memory and one or more processors coupled to the memory. The one or more processors may be configured to transmit configuration information indicating. The one or more processors may be configured to receive one or more communications via the first component carrier and the second component carrier based at least in part the first set of multiple TAGs and the second set of one or more TAGs.

Some aspects described herein relate to a network node for wireless communication. The network node may include a memory and one or more processors coupled to the memory. The one or more processors may be configured to receive an indication of a capability to communicate with multiple TAs for a single component carrier. The one or more processors may be configured to transmit configuration information indicating multiple CORESET pool indexes for communication within the single component carrier, and one or more TAG) for the single component carrier based at least in part on the capability.

Some aspects described herein relate to a non-transitory computer-readable medium that stores a set of instructions for wireless communication by a UE. The set of instructions, when executed by one or more processors of the UE, may cause the UE to receive configuration information indicating. The set of instructions, when executed by one or more processors of the UE, may cause the UE to transmit one or more communications via the first component carrier and the second component carrier based at least in part the first set of multiple TAGs and the second set of one or more TAGS.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to transmit an indication of a capability to communicate with multiple TAs for a single component carrier. The set of instructions, when executed by one or more processors of the one or more instructions that, when executed by one or more processors of a UE, may cause the one or more instructions that, when executed by one or more processors of a UE to receive configuration information indicating multiple CORESET pool indexes for communication within the single component carrier, and one or more TAG) for the single component carrier based at least in part on the capability.

Some aspects described herein relate to a non-transitory computer-readable medium that stores a set of instructions for wireless communication by a network node. The set of instructions, when executed by one or more processors of the network node, may cause the network node to transmit configuration information indicating. The set of instructions, when executed by one or more processors of the network node, may cause the network node to receive one or more communications via the first component carrier and the second component carrier based at least in part the first set of multiple TAGs and the second set of one or more TAGS.

Some aspects described herein relate to a non-transitory computer-readable medium that stores a set of instructions for wireless communication by a network node. The set of instructions, when executed by one or more processors of the network node, may cause the network node to receive an indication of a capability to communicate with multiple TAs for a single component carrier. The set of instructions, when executed by one or more processors of the network node, may cause the network node to transmit configuration information indicating multiple CORESET pool indexes for communication within the single component carrier, and one or more TAG) for the single component carrier based at least in part on the capability.

Some aspects described herein relate to an apparatus for wireless communication. The apparatus may include means for receiving configuration information indicating, a first configuration of multiple CORESET pool indexes for a first component carrier and for a second component carrier, and a second configuration of a first set of multiple TAGs for the first component carrier and a second set of one or more TAGS for the second component carrier, where the second set of one or more TAGs is configured based at least in part the first set of multiple TAGs. The apparatus may include means for transmitting one or more communications via the first component carrier and the second component carrier based at least in part the first set of multiple TAGs and the second set of one or more TAGS.

Some aspects described herein relate to an apparatus for wireless communication. The apparatus may include means for transmitting an indication of a capability to communicate with multiple TAs for a single component carrier. The apparatus may include means for receiving configuration information indicating, multiple CORESET pool indexes for communication within the single component carrier, and one or more TAGS for the single component carrier based at least in part on the capability multiple CORESET pool indexes for communication within the single component carrier, and one or more TAG) for the single component carrier based at least in part on the capability.

Some aspects described herein relate to an apparatus for wireless communication. The apparatus may include means for transmitting configuration information indicating, a first configuration of multiple CORESET pool indexes for a first component carrier and for a second component carrier, and a second configuration in of a first set of multiple TAGs for the first component carrier and a second set of one or more TAGS for the second component carrier, where the second set of one or more TAGs is configured based at least in part the first set of multiple TAGs. The apparatus may include means for receiving one or more communications via the first component carrier and the second component carrier based at least in part the first set of multiple TAGs and the second set of one or more TAGS.

Some aspects described herein relate to an apparatus for wireless communication. The apparatus may include means for receiving an indication of a capability to communicate with multiple TAs for a single component carrier. The apparatus may include means for transmitting configuration information indicating: multiple CORESET pool indexes for communication within the single component carrier, and one or more TAGS for the single component carrier based at least in part on the capability.

Aspects generally include a method, apparatus, system, computer program product, non-transitory computer-readable medium, user equipment, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multi-transmission-reception point (multi-TRP) communication, in accordance with the present disclosure.

FIG. 6 is a diagram illustrating an example of transmission reception point (TRP) differentiation at a UE based at least in part on a control resource set (CORESET) pool index, in accordance with the present disclosure.

FIG. 7 is a diagram illustrating an example of downlink and uplink transmissions between a network node and a UE in a wireless network, in accordance with the present disclosure.

FIG. 8 is a diagram illustrating examples of carrier aggregation, in accordance with the present disclosure.

FIG. 9 is a diagram illustrating an example of configuring timing advance groups (TAGs) for component carriers, in accordance with the present disclosure.

FIGS. 10-13 are diagrams illustrating example processes associated with configuring TAGs for component carriers, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

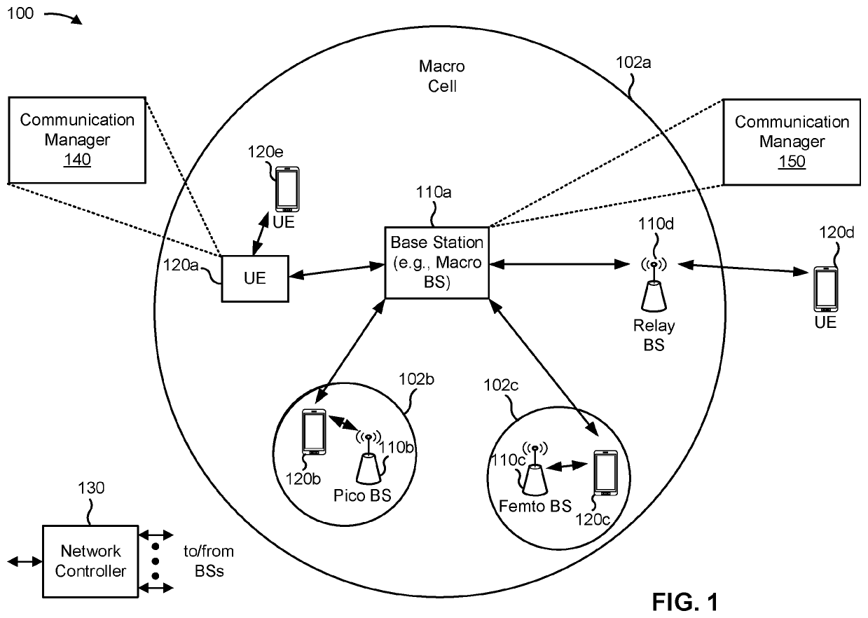

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating: a first configuration of multiple control resource set (CORESET) pool indexes for a first component carrier and for a second component carrier, and a second configuration of a first set of multiple timing advance groups (TAGs) for the first component carrier and a second set of one or more TAGS for the second component carrier, wherein the second set of one or more TAGs is configured based at least in part the first set of multiple TAGs; and transmit one or more communications via the first component carrier and the second component carrier based at least in part the first set of multiple TAGs and the second set of one or more TAGS. As described in more detail elsewhere herein, the communication manager 140 may transmit an indication of a capability to communicate with multiple timing advances (TAs) for a single component carrier; and receive configuration information indicating: multiple CORESET pool indexes for communication within the single component carrier, and one or more TAGS for the single component carrier based at least in part on the capability. Additionally, or alternatively, the communication manager 140 may perform one or more other operations described herein.

In some aspects, the network node (e.g., a base station 110 or a device associated with a base station 110, among other examples) may include a communication manager 150. As described in more detail elsewhere herein, the communication manager 150 may transmit configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs; and receive one or more communications via the first component carrier and the second component carrier based at least in part the first set of multiple TAGs and the second set of one or more TAGS. As described in more detail elsewhere herein, the communication manager 150 may receive an indication of a capability to communicate with multiple TAs for a single component carrier; and transmit configuration information indicating: multiple CORESET pool indexes for communication within the single component carrier, and one or more TAGS for the single component carrier based at least in part on the capability. Additionally, or alternatively, the communication manager 150 may perform one or more other operations described herein.

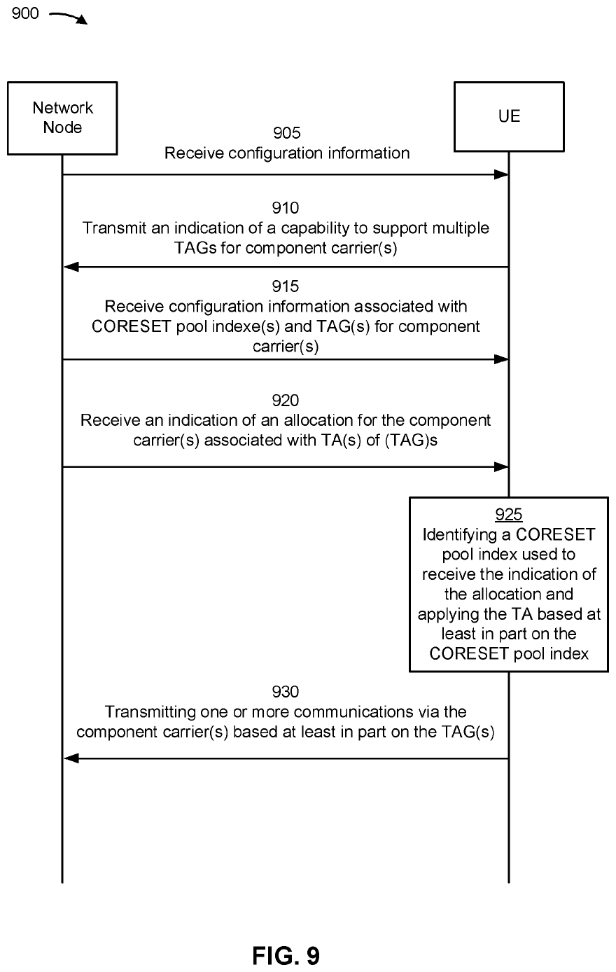

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity.” may refer to one of the base station functions and not another. In this way, a single device may include more than one base station.

As indicated above, FIG. 1 is provided as an example. Other examples may differ from what is described with regard to FIG. 1.

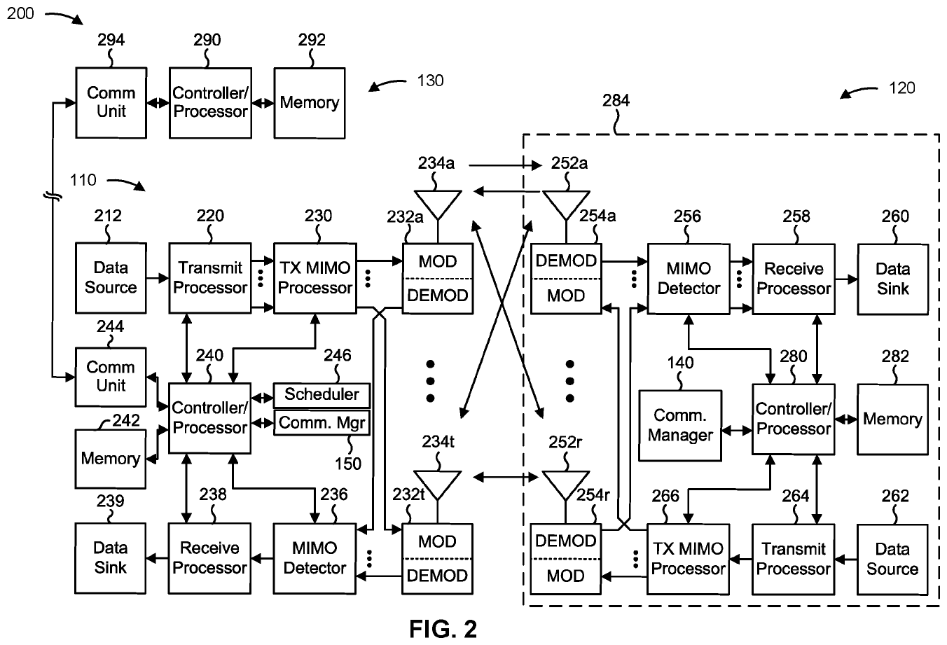

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-15).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-15).

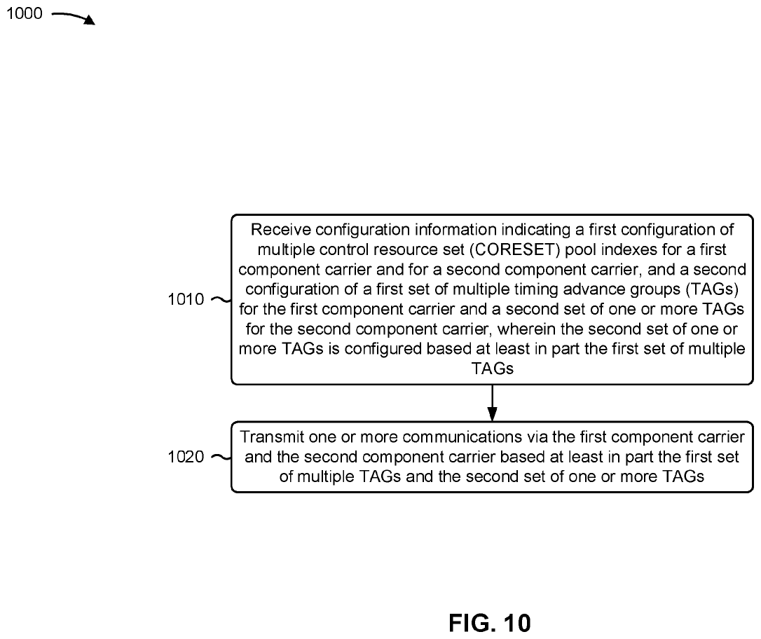

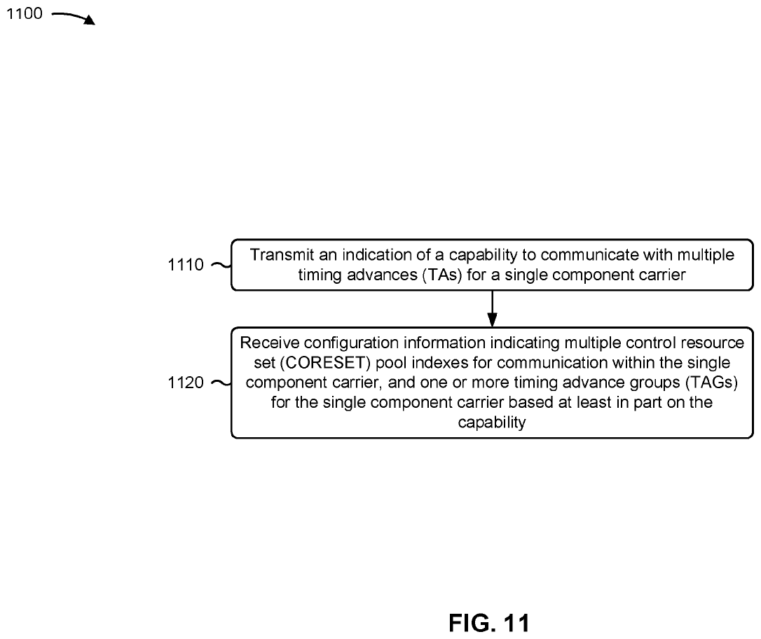

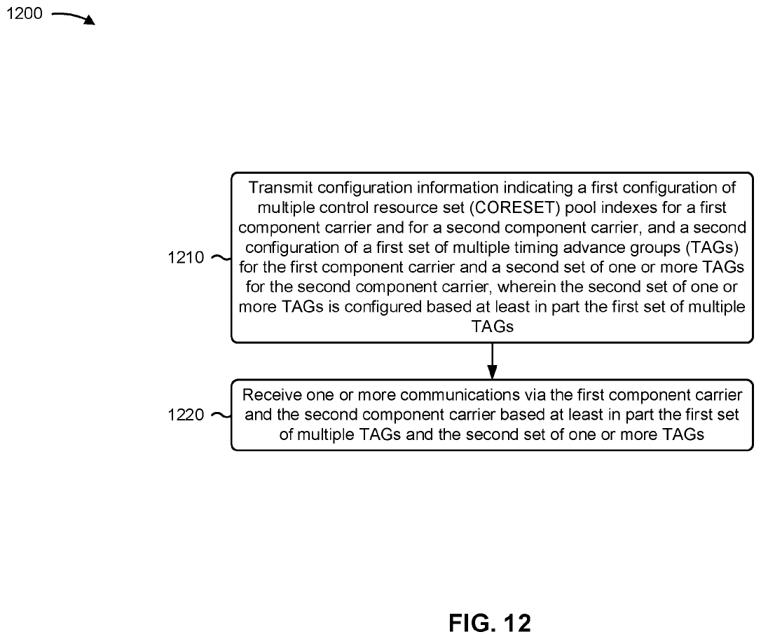

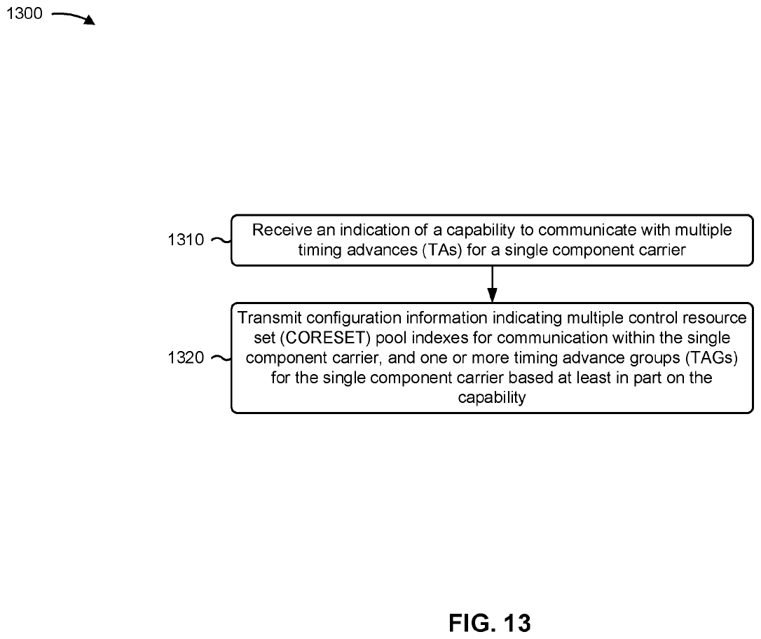

The controller/processor 240 of the base station 110, the controller/processor 280 of the UE 120, and/or any other component(s) of FIG. 2 may perform one or more techniques associated with configuring TAGs for component carriers, as described in more detail elsewhere herein. In some aspects, the network node described herein is the base station 110 (e.g., a TRP or a base station associated with TRPs), is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE includes means for receiving configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs; and/or means for transmitting one or more communications via the first component carrier and the second component carrier based at least in part the first set of multiple TAGs and the second set of one or more TAGs. In some aspects, the UE includes means for transmitting an indication of a capability to communicate with multiple TAs for a single component carrier; and/or means for receiving configuration information indicating multiple CORESET pool indexes for communication within the single component carrier, and one or more TAGS for the single component carrier based at least in part on the capability. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGS; and/or means for receiving one or more communications via the first component carrier and the second component carrier based at least in part the first set of multiple TAGs and the second set of one or more TAGS. In some aspects, the network node includes means for receiving an indication of a capability to communicate with multiple TAs for a single component carrier; and/or means for transmitting configuration information indicating multiple CORESET pool indexes for communication within the single component carrier, and one or more TAGS for the single component carrier based at least in part on the capability. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

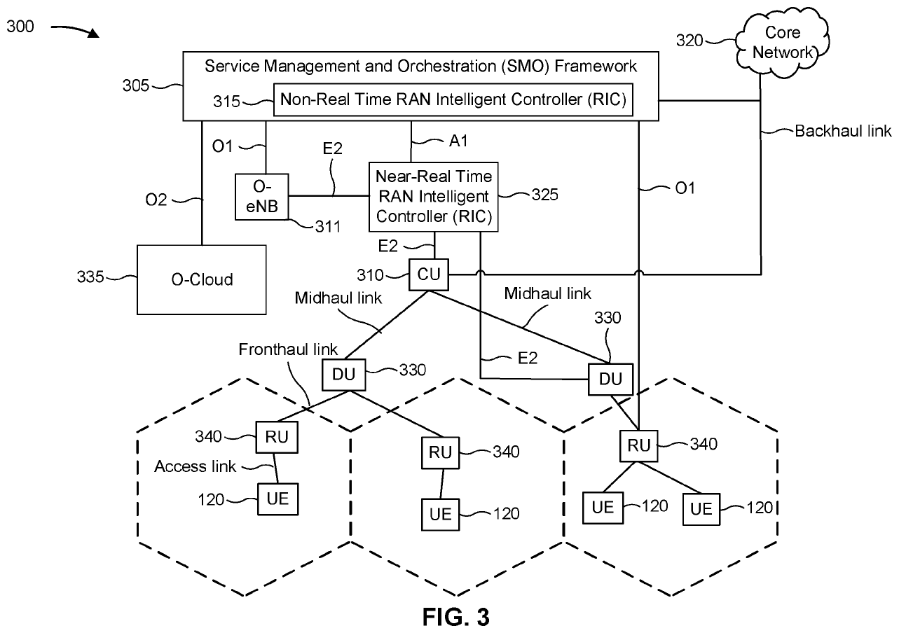

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a radio access node (RAN) node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 335) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

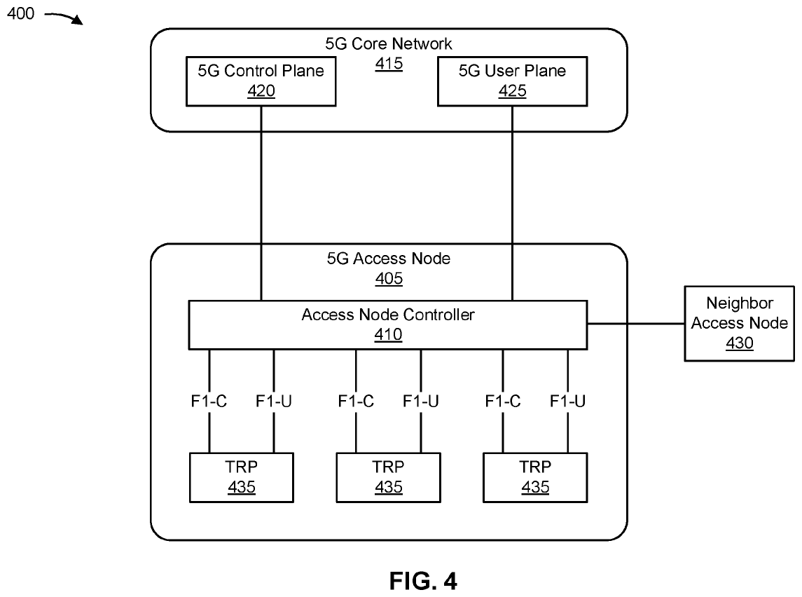

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-colocation (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE.

As indicated above, FIG. 4 is provided as an example. Other examples may differ from what was described with regard to FIG. 4.

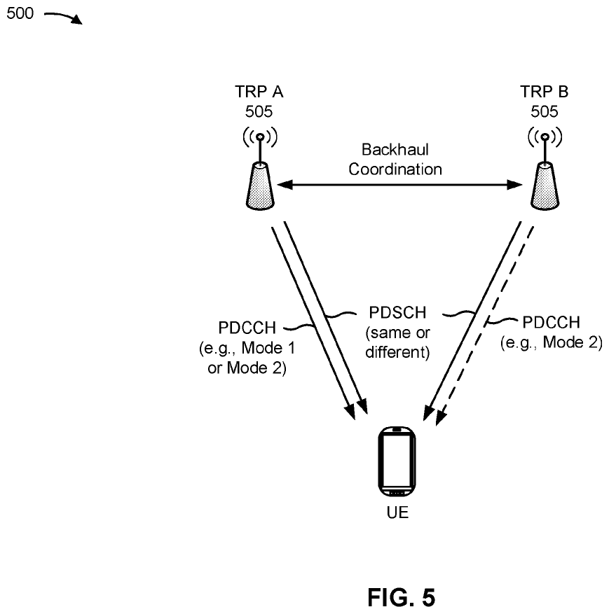

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE. A TRP 505 may correspond to a TRP 435 described above in connection with FIG. 4.

The multiple TRPs 505 (shown as TRP A and TRP B) may communicate with the same UE in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110) and may have a larger delay and/or lower capacity (as compared to co-location) when the TRPs 505 are located at different base stations 110. The different TRPs 505 may communicate with the UE using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

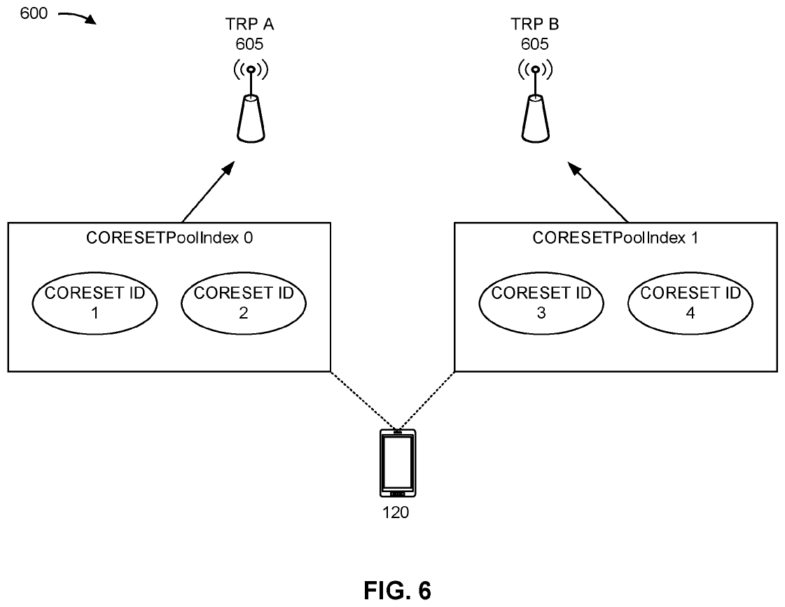

FIG. 6 is a diagram illustrating an example 600 of TRP differentiation at a UE based at least in part on a CORESET pool index, in accordance with the present disclosure. In some aspects, a CORESET pool index (or CORESETPoolIndex) value may be used by a UE (a UE) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE may be configured with multiple CORESETs in a given serving cell. Each CORESET configured for the UE may be associated with a CORESET identifier (CORESET ID). For example, a first CORESET configured for the UE may be associated with CORESET ID 1, a second CORESET configured for the UE may be associated with CORESET ID 2, a third CORESET configured for the UE may be associated with CORESET ID 3, and a fourth CORESET configured for the UE may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 6 is provided as an example. Other examples may differ from what is described with respect to FIG. 6.

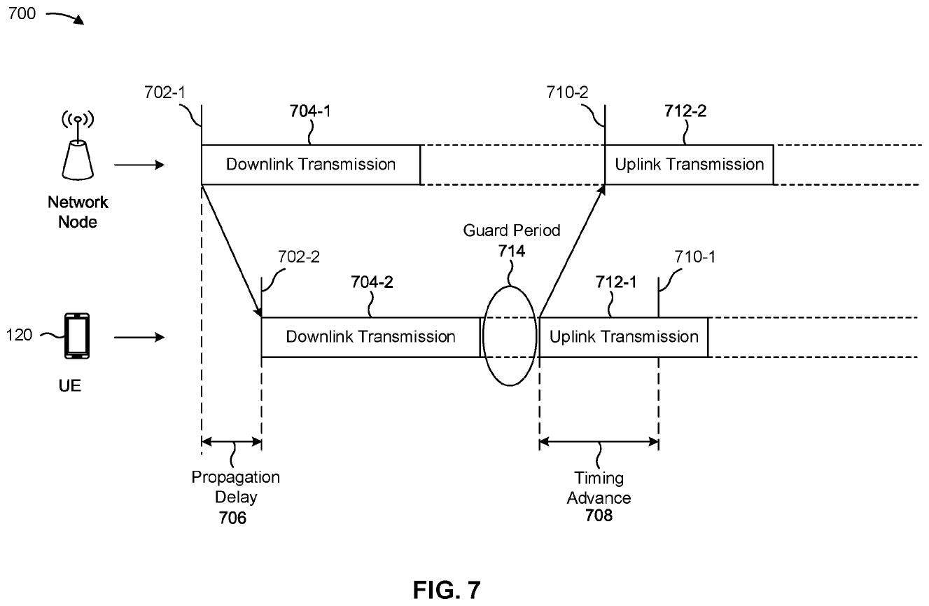

FIG. 7 is a diagram illustrating an example 700 of downlink and uplink transmissions between a network node (e.g., a TRP) and a UE in a wireless network, in accordance with the present disclosure. In some examples, the downlink and/or uplink transmissions are based at least in part on a timing advance and/or a guard period between communications. As one example, the network node (e.g., TRP) may configure a downlink transmission to end before the start of a guard period. As another example, the UE may advance a start time for an uplink transmission based at least in part on a timing advance.

As shown by reference number 702-1, the network node may begin a downlink transmission 704-1 to a UE at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 702-1 may be based at least in part on a time partition as defined by a telecommunication system (e.g., a frame, a subframe, a slot, a mini-slot, and/or a symbol).

In some examples, the network node and the UE may wirelessly communicate with one another based at least in part on the defined time partitions. However, each device may have different timing references for the time partitions. To illustrate, and as shown by the reference number 702-1, the network node may begin the downlink transmission 704-1 at a particular point in physical time that may be associated with a defined time partition based at least in part on a time perspective of the network node. For example, the network node may associate the particular point in physical time with a defined time partition, such as a beginning of a symbol, a beginning of a slot, a beginning of a subframe, and/or a beginning of a frame. However, the downlink transmission may incur a propagation delay 706 in physical time, such as a time delay based at least in part on the downlink transmission traveling between the network node and the UE. As shown by reference number 702-2, the UE may receive downlink transmission 704-2 (corresponding to downlink transmission 704-1 transmitted by the network node) at a second point in physical time that is later in time relative to the first point in physical time. From a time perspective of the UE, however, the UE may associate the second point in physical time shown by the reference number 702-2 with the same particular point in time of the defined time partition as the network node (e.g., a beginning of the same symbol, a beginning of the same mini-slot, a beginning of the same slot, a beginning of the same subframe, and/or a beginning of the same frame). Thus, as shown by the example 700, the time perspective of the UE may be delayed in physical time from the time perspective of the network node.

In wireless communication technologies like 4G/LTE and 5G/NR, a TA value is used to control a timing of uplink transmissions by a UE (e.g., UE and/or the like) such that the uplink transmissions are received by a network node (e.g., a TRP and/or an RU, among other examples) at a time that aligns with an internal timing of the network node. The network node may indicate the TA value to a UE by measuring a time difference between reception of uplink transmissions from the UE and a subframe timing used by the network node (e.g., by determining a difference between when the uplink transmissions were supposed to have been received by the network node, according to the subframe timing, and when the uplink transmissions were actually received), and by transmitting a TA command (TAC) to instruct the UE to transmit future uplink communications earlier or later to reduce or eliminate the time difference and align timing between the UE and network node. The TA command is used to offset timing differences between the UE and the network node due to different propagation delays that occur when the UE is different distances from the network node. If TA commands were not used, then uplink transmissions from different UEs (e.g., located at different distances from the network node) may collide due to mistiming even if the uplink transmissions are scheduled for different subframes.

To illustrate, without adjusting a start time of an uplink transmission, the UE may be configured to begin an uplink transmission at a scheduled point in time based at least in part on the defined time partitions as described elsewhere herein. As shown by reference number 710-1, a start of the scheduled point in time may occur at a third physical point in time based at least in part on the timing perspective of the UE. However, and as shown by reference number 710-2, the scheduled point in time with reference to the timing perspective of the network node may occur at a fourth point in physical time that occurs before the third point in physical time as shown by the reference number 710-1. Accordingly, the network node may instruct the UE to apply a timing advance 708 to an uplink transmission to better align reception of the uplink transmission with the timing perspective of the network node. However, in some examples, the fourth point in time shown by the reference number 710-2 may occur at or near a same physical point in time as the third point in time shown by the reference number 710-1 such that uplink transmissions from the UE to the network node incur the propagation delay 706. In such a scenario, the network node may instruct the UE to apply a timing advance with a time duration corresponding to the propagation delay 706.

As shown by the example 700, the UE may adjust a start time of an uplink transmission 712-1 based at least in part on the timing advance 708 and the start of the scheduled point in time (e.g., at the third physical point in time shown by the reference number 710-1). Based at least in part on propagation delay, the network node may receive an uplink transmission 712-2 (corresponding to the uplink transmission 712-1 transmitted by the UE) at the fourth point in physical time shown by the reference number 710-2.

In some examples, a timing advance value may be based at least in part on twice an estimated propagation delay (e.g., the propagation delay 706) and/or may be based at least in part on a round trip time (RTT). The network node may estimate the propagation delay and/or select a timing advance value based at least in part on communications with the UE. As one example, the network node may estimate the propagation delay based at least in part on a network access request message from the UE. Additionally, or alternatively, the network node may estimate and/or select the timing advance value from a set of fixed timing advance values.

In some examples, a telecommunication system and/or telecommunication standards may define a guard period 714 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 714 may sometimes be referred to as a gap, a switching guard period, or a guard interval.

In some examples, a transmitting device (e.g., the network node, a CU, a DU, and/or an RU) may select a starting transmission time and/or a transmission time duration based at least in part on a receiving device and/or the guard period. For example, the network node may select an amount of content (e.g., data and/or control information) to transmit in the downlink transmission 704-1 based at least in part on beginning the transmission at the first point in physical time shown by the reference number 702-1 and/or the UE completing reception of the downlink transmission 704-2 prior to a starting point of the guard period 714. Alternatively, or additionally, the UE may select an amount of content (e.g., data and/or control information) to transmit in the uplink transmission 712-1 based at least in part on the timing advance 708, the third point in physical time shown by the reference number 710-1, and/or refraining from beginning the uplink transmission 712-1 until the guard period 714 has ended.

As indicated above, FIG. 7 is provided as an example. Other examples may differ from what is described with regard to FIG. 7.

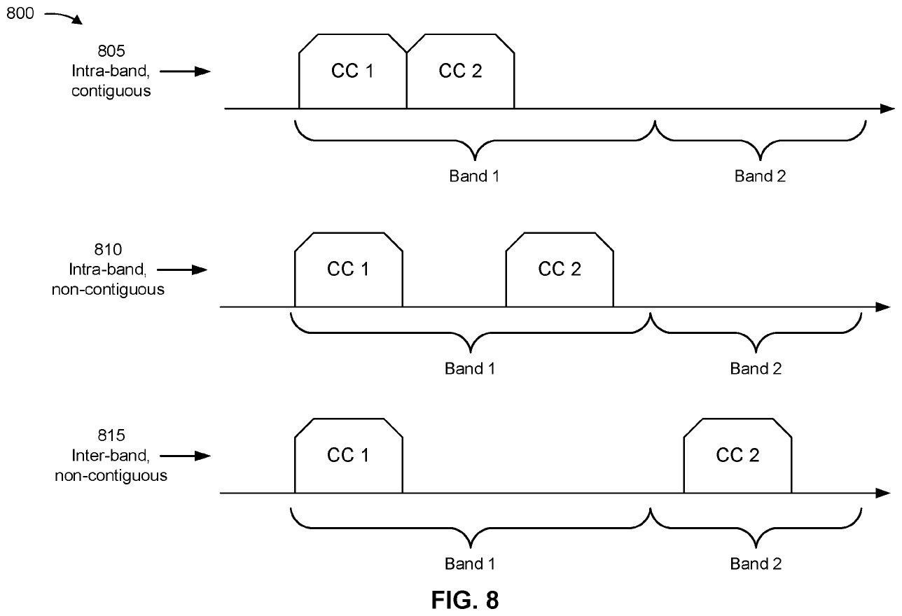

FIG. 8 is a diagram illustrating examples 800 of carrier aggregation, in accordance with the present disclosure.

Carrier aggregation is a technology that enables two or more component carriers (CCs, sometimes referred to as carriers) to be combined (e.g., into a single channel) for a single UE to enhance data capacity. As shown, carriers can be combined in the same or different frequency bands. Additionally, or alternatively, contiguous or non-contiguous carriers can be combined. A network node may configure carrier aggregation for a UE, such as in an RRC message, DCI, and/or another signaling message.

As shown by reference number 805, in some aspects, carrier aggregation may be configured in an intra-band contiguous mode where the aggregated carriers are contiguous to one another and are in the same band. As shown by reference number 810, in some aspects, carrier aggregation may be configured in an intra-band non-contiguous mode where the aggregated carriers are non-contiguous to one another and are in the same band. As shown by reference number 815, in some aspects, carrier aggregation may be configured in an inter-band non-contiguous mode where the aggregated carriers are non-contiguous to one another and are in different bands.

In carrier aggregation, a UE may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 8 is provided as an example. Other examples may differ from what is described with regard to FIG. 8.

In some networks, a multi-DCI based multi-TRP configuration includes a first DCI (transmitted from a first TRP) that schedules a first data channel (e.g., a first PDSCH) that is transmitted to or received from the first TRP. The multi-DCI based multi-TRP configuration also includes a second DCI (e.g., transmitted from a second TRP) that schedules a second data channel (e.g., a second PDSCH) transmitted from the second TRP.

The UE may differentiate communications (e.g., DCI or a data communication) from the first TRP and the second TRP based at least in part on a CORESET pool index (e.g., CORESETPoolIndex) associated with the DCI. The UE may be associated a DCI and a scheduled data communication with a TRP based at least in part on receiving the DCI in a resource of a CORESET having a CORESET pool index. For example, the UE may associate first DCI and first scheduled data communications with the first TRP based at least in part on receiving the first DCI in a CORESET having a CORESET pool index of 0 and may associate a second DCI and second scheduled data communications with a second TRP based at least in part on receiving the DCI in a CORESET having a CORESET pool index of 1. The CORESETPoolIndex of the CORESET in which a DCI is received may be used for different purposes such as for transmitting hybrid automatic repeat request (HARQ) acknowledgment (HARQ-ACK) feedback to a TRP that transmitted the DCI and the scheduled data communication.

In some networks, the UE may determine whether the UE is configured with multi-DCI based multi-TRP configuration in a given component carrier based at least in part on the UE being configured with multiple different values of a CORESET pool index for an active bandwidth part (BWP) of a serving cell. For example, the UE may be configured by a higher layer parameter (e.g., an RRC parameter, such as PDCCH-Configure) that contains two different values of CORESETPoolIndex in CORESETs for the active BWP of the serving cell.

In some networks, each serving cell may be associated with one TAG. For example, a selected TA value from the TAG may be applied to uplink transmissions on the serving cell. This may be based at least in part on the TAG being applied to communications with a single network node and/or TRP. In this case, only a single TA may be necessary based at least in part on communications with the single network node and/or TRP that may follow a same beam path and may not vary in propagation time by an amount that satisfies a threshold (e.g., an amount that causes communication errors, such as an amount that exceeds a cyclic prefix).

In some networks, two TAs for uplink in a multi-DCI multi-TRP configuration may be specified. In this case, different TRPs may have different TA values. For example, the timing advance 708 of FIG. 7 may be less for a first TRP than for a second TRP. This may be based at least in part on communications with different TRPs that follow different beam paths and may vary in propagation time by an amount that satisfies a threshold. For example, the first TRP may communicate with the UE via a communication path that is shorter than a propagation path of communication between the UE and a second TRP, resulting in a shorter propagation delay 706 for communications with the first TRP than for communications with the second TRP. The difference in propagation path lengths may be based at least in part on the first TRP being located at a location that is nearer to the UE and/or based at least in part on the first TRP having fewer reflections in the propagation path (e.g., a line-of-sight path).

In some networks, in a multi-DCI multi-TRP configuration, a UE may be configured with two CORESET pool index values in the CORESETs for the active BWP of a serving cell. Some component carriers may be configured with multiple CORESET pool index values (e.g., if in a multi-DCI multi-TRP configuration) while others may be configured with single CORESET pool index value (e.g., if not in a multi-DCI multi-TRP configuration).

In some networks, when multiple uplink TAs are supported, the UE may be configured with two TAGs for a component carrier. In this case, some component carriers may be configured with multiple TAGs while others may be configured with a single TAG. If a component carrier is not configured with multiple CORESET pool index values (e.g., multi-DCI based multi-TRP), the component carrier may be configured with only a single TAG. However, if a serving cell is configured with multiple CORESET pool index values, the UE and/or the network node may be unable to determine whether a single TAG or multiple TAGs can be configured for the component carrier. In this way, the network node and the UE may unnecessarily consume power, computing, network, and/or communication resources to identify and communicate a TA when an unnecessarily high number of TAGs are configured. For example, overhead may increase and/or control channel monitoring may be excessive based at least in part on configuring multiple TAGs when fewer TAGs are needed.

In some aspects described herein, configurations of TAGs for a component carrier may be prohibited or allowed based at least in part on a number of CORESET pool indexes configured for the component carrier. Similarly, a number of CORESET pool indexes that are configurable for a component carrier may be prohibited or allowed based at least in part on a number of TAGs configured for the component carrier.

In some aspects, if a UE is configured with multiple component carriers, for any two component carriers that are each configured with two CORESET pool index values, the UE may not be configured (e.g., may not expect to be configured) with the first component carrier configured with two TAGs and the second component carrier configured with a single TAG. For example, if a first component carrier is configured with two CORESET pool index values and two TAGs, then a second component carrier should also be configured with multiple TAGs (e.g., a same number of TAGs as the first component carrier) if the second component carrier is configured with two CORESETPoolIndex values. Similarly, if a first component carrier is configured with two CORESET pool index values and two TAGs, then the second component carrier is not allowed to be configured with multiple CORESET pool index values if the second component carrier is configured with single TAG.

In some aspects, if a UE is configured with multiple component carriers, for any two component carriers that are each configured with two CORESET pool index values, the UE may be configurable such that the first component carrier is configured with two TAGs and the second component carrier is configured with a single TAG if one or more conditions are satisfied. For example, the second component carrier may be configured with a single TAG based at least in part on the single TAG of the second component carrier being different from each of the two TAGs of the first component carrier. Additionally, or alternatively, the second component carrier may be configured with a single TAG based at least in part on the first component carrier and the second component carrier being on different bands (e.g., as described in connection with FIG. 8).

Based at least in part on a number of TAGs of different component carriers being dependent on one or more conditions, the UE and the network node may conserve power, computing, network, and/or communication resources that may have otherwise been used to identify and communicate a TA when an unnecessarily high number of TAGs are configured. For example, overhead may be conserved and/or control channel monitoring may be reduced based at least in part on configuring multiple TAGs when multiple TAGs are likely to be used (e.g., when different component carriers are likely to be used for communications with different TAs, propagation paths, and/or propagation delays).

In some networks, a UE may be configured with a single component carrier for communication. If a component carrier is configured with multiple CORESET pool index values, the UE may communication with different TRPs within the single component carrier. As described herein, propagation paths for communications with different TRPs may be different, which may lead to different TAs. However, some UEs may support multiple TAGs for communications within a single component carrier and other UEs may not support multiple TAGs for communication within a single component carrier. If the UE supports multiple TAGs, using the multiple TAGs may improve TAs and reduce communication errors caused by configuring a single TA for communications with different TRPs having different propagation delays. However, if the UE does not support multiple TAGs for the single component carrier, attempting to configure the UE with multiple TAGs may result in communication errors based at least in part on the UE being unable to correctly identify an indicated TA from the multiple TAGs.

In some aspects, the UE may be configured with multiple TAGs for a single component carrier based at least in part on a UE capability. For example, if the UE is capable of multiple TA operations for a single component carrier, the UE may be permitted to be configured with multiple TAGs. If the UE is not capable of multiple TA operations for a single component carrier, the UE may be prohibited from being configured with multiple TAGs. In this case, only a single TAG can be configured for the component carrier.

Based at least in part on a number of TAGs with which the UE can be configured being based at least in part on a capability of the UE (e.g., as indicated to a network node), the UE may improve TA application when supporting multiple TAGs, which may reduce communication errors and communication, network, power, and/or computing resources that may have otherwise been consumed to detect and correct the communication errors. Additionally, or alternatively, the UE may improve TA application when supporting only a single TAG based at least in part on the UE improving an ability to correctly identify an indicated TA from a single TAG instead of multiple tags, which may reduce communication errors that may have otherwise been caused by failing to apply the indicated TA.

FIG. 9 is a diagram of an example 900 associated with configuring TAGs for component carriers, in accordance with the present disclosure. As shown in FIG. 9, a network node (e.g., base station 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 9. In some aspects, the network node may communicate with the UE via one or more TRPs, relays, forwarding nodes, and/or repeater nodes, among other examples. The one or more TRPs, relays, forwarding nodes, and/or repeater nodes, among other examples may be associated with different beam paths, propagation paths, and/or propagation delays, among other examples.

As shown by reference number 905, the network node may transmit, and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit an indication of support for multiple TAGs for a single component carrier and/or support for multiple TAGs for different component carriers. In some aspects, the UE may indicate a number of component carriers supported by the UE and/or a number of TAGs supported by the UE.

The UE may configure itself based at least in part on the configuration information. In some aspects, the UE may be configured to perform one or more operations described herein based at least in part on the configuration information.

As shown by reference number 910, the UE may transmit, and the network node may receive, an indication of a capability to support TAGs for one or more component carriers. For example, the UE may indicate a capability to support multiple TAGs for a single component carrier. Additionally, or alternatively, the UE may indicate support for a number of TAGs and/or CORESET pool indexes for component carriers used in communication with the network node (e.g., with TRPs associated with the network node). For example, the UE may indicate that the UE supports multiple CORESET pool indexes for one or more component carriers (e.g., all component carriers) and/or may indicate support for multiple CORESET pool indexes for component carriers based at least in part on bands of the component carriers, among other examples.

In some aspects, the indication of the capability may indicate that the UE supports communicating with multiple TAs for a single component carrier. For example, the UE may have the capability based at least in part on a configuration of the UE, communication resources at the UE (e.g., antennas and/or transmission chains, among other examples), power resources available at the UE, and/or computing resources available at the UE, among other examples.

In some aspects, the UE may receive a first portion of the configuration information described in connection with reference number 905 before transmitting the indication of the capability and may receive a second portion of the configuration information after transmitting the indication of the capability.

As shown by reference number 915, the UE may receive, and the network node may transmit, configuration information associated with one or more CORESET pool indexes and one or more TAGS for one or more component carriers. For example, the UE may receive an indication of a first component carrier, an indication of one or more CORESET pool indexes for the component carrier, and in indication of one or more TAGs associated with the component carrier and/or mapped to the one or more CORESET pool indexes (e.g., a first TAG mapped to a first CORESET pool index value and/or a second TAG mapped to a second CORESET pool index value, or a single TAG mapped to the component carrier and multiple or all CORESET pool index values of the component carrier, among other examples).

In some aspects, the configuration information may indicate a first configuration of multiple CORESET pool indexes for a first component carrier and for a second component carrier. The configuration information may also indicate a second configuration of a first set of multiple TAGs for the first component carrier and a second set of one or more TAGS for the second component carrier. The second set of one or more TAGs may be configured based at least in part the first set of multiple TAGs. For example, the second set of one or more TAGS is configured with multiple TAGs based at least in part on the first set of multiple TAGs being configured with multiple TAGs. Additionally, or alternatively, the second set of one or more TAGS may be configured with a same number of TAGs as the first set of multiple TAGs.

In some aspects, the second set of one or more TAGS may be configured with dependency on (e.g., based at least in part on) the first set of multiple TAGs based at least in part on the first component carrier being configured with multiple CORESET pool indexes and the second component carrier being configured with multiple CORESET pool indexes. Additionally, or alternatively, second set of one or more TAGs may be configured without dependency on (e.g., independently from) the first set of multiple TAGs based at least in part on the first component carrier being configured with a single CORESET pool index or the second component carrier being configured with a single CORESET pool index.

In some aspects, the second component carrier may be configurable with multiple CORESET pool indexes based at least in part on the second set of one or more TAGs being configured with multiple TAGs. For example, the UE may be configured such that the UE maybe configured with multiple component carriers so long as each component carrier having multiple CORESET pool indexes has a same number of TAGs.

In some aspects, a second set of TAGs (e.g., associated with the second component carrier) may be configurable with a single TAG when a first set of TAGs (e.g., associated with the first component carrier) is configured with multiple TAGs based at least in part on the single TAG of the second set of TAGs being a different TAG from each TAG of the first set of TAGs (e.g., the single tag not being included in the first set of multiple TAGs and/or the first component carrier and the second component carrier being in different frequency bands (e.g., bands of FIG. 8), among other examples). In some aspects, the first component carrier may have a different number of TAGs than the second component carrier based at least in part on a band of the first component carrier having different propagation characteristics (e.g., propagation loss, objects that reflect signals or let signals pass) than propagation characteristics of the second component carrier. For example, the first component carrier may be on a band that passes through objects, such as tree branches, leaves, and/or other objects, while the second component carrier may be on a band that reflects off of tree branches, leaves, and/or other objects. In this case, the UE may transmit a communication to a TRP using a different beam path based at least in part on the propagation characteristics of the component carriers at different bands.

In some aspects, the configuration information may indicate multiple CORESET pool indexes for communication within a single component carrier and one or more TAGS for the single component carrier based at least in part on a capability of the UE. For example, the UE may be configured to communicate with multiple TAGs within a single component carrier based at least in part on the UE indicating a capability to support the multiple TAGs within the single component carrier. In some aspects, the configuration information indicates multiple TAGs for the single component carrier based further in part on the multiple CORESET pool indexes being associated with different propagation times to one or more network nodes (e.g., TRPs). In some aspects, the UE may be configured with multiple TAGs for the single component carrier based at least in part on the propagation times to the one or more network nodes that differ by an amount that satisfies a threshold. For example, the threshold may be based at least in part on a cyclic prefix associated with communications via the first component carrier or the second component carrier.

As shown by reference number 920, the UE may receive, and the network node may transmit, an indication of an allocation for the one or more component carriers associated with one or more TAs of one or more TAGS.

As shown by reference number 925, the UE may identify a CORESET pool index used to receive the indication of the allocation and apply the TA based at least in part on the CORESET pool index. For example, the UE may receive the indication of the allocation within a CORESET of a component carrier and having a CORESET pool index that maps to a TAG. The indication of the allocation may indicate a TA of the TAG for the allocation. For example, the indication of the allocation may indicate an index of the TA within a TAG that maps to the CORESET pool index (e.g., the UE determines the TAG to which the index of the TA applies based at least in part on the CORESET pool index).

As shown by reference number 930, the UE may transmit one or more communications via the one or more component carriers based at least in part on the one or more TAGs. In some aspects, the UE may transmit the one or more communications using inter-band carrier aggregation via the first component carrier and the second component carrier (e.g., if configured with multiple component carriers). In some aspects, the UE may transmit the one or more communications using a single component carrier and/or one or more TAs (e.g., if configured with a single component carrier) based at least in part on a capability of the UE.

Based at least in part on a number of TAGs of different component carriers being dependent on one or more conditions, the UE and the network node may conserve power, computing, network, and/or communication resources that may have otherwise been used to identify and communicate a TA when an unnecessarily high number of TAGs are configured. For example, overhead may be conserved and/or control channel monitoring may be reduced based at least in part on configuring multiple TAGs when multiple TAGs are likely to be used (e.g., when different component carriers are likely to be used for communications with different TAs, propagation paths, and/or propagation delays).

Additionally, or alternatively, based at least in part on a number of TAGs with which the UE can be configured for a single component carrier being based at least in part on a capability of the UE (e.g., as indicated to a network node), the UE may improve TA application when supporting multiple TAGs. This may reduce communication errors and communication, network, power, and/or computing resources that may have otherwise been consumed to detect and correct the communication errors. Additionally, or alternatively, the UE may improve TA application when supporting only a single TAG based at least in part on the UE improving an ability to correctly identify an indicated TA from a single TAG instead of multiple tags, which may reduce communication errors that may have otherwise been caused by failing to apply the indicated TA.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with configuring timing advance groups for component carriers.

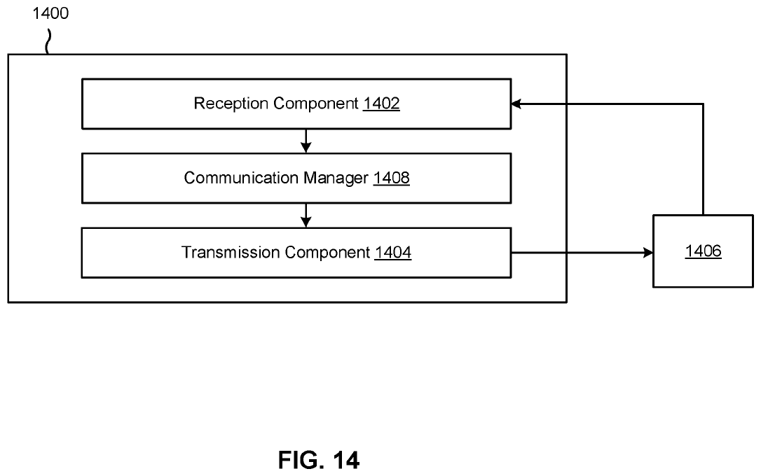

As shown in FIG. 10, in some aspects, process 1000 may include receiving configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs (block 1010). For example, the UE (e.g., using communication manager 140 and/or reception component 1402, depicted in FIG. 14) may receive configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs, as described above.

As further shown in FIG. 10, in some aspects, process 1000 may include transmitting one or more communications via the first component carrier and the second component carrier based at least in part the first set of multiple TAGs and the second set of one or more TAGS (block 1020). For example, the UE (e.g., using communication manager 140 and/or transmission component 1404, depicted in FIG. 14) may transmit one or more communications via the first component carrier and the second component carrier based at least in part the first set of multiple TAGs and the second set of one or more TAGS, as described above.

Process 1000 may include additional aspects, such as any single aspect or any combination of aspects described below and/or in connection with one or more other processes described elsewhere herein.

In a first aspect, the second set of one or more TAGs is configured with a same number of TAGs as the first set of multiple TAGs.

In a second aspect, alone or in combination with the first aspect, the second set of one or more TAGs is configured with multiple TAGs based at least in part on the first set of multiple TAGs being configured with multiple TAGs.

In a third aspect, alone or in combination with one or more of the first and second aspects, the second set of one or more TAGs is configured based at least in part on the first set of multiple TAGs based at least in part on the first component carrier being configured with multiple CORESET pool indexes, and the second component carrier being configured with multiple CORESET pool indexes.

In a fourth aspect, alone or in combination with one or more of the first through third aspects, the second component carrier is configurable with multiple CORESET pool indexes based at least in part on the second set of one or more TAGS being configured with multiple TAGs.

In a fifth aspect, alone or in combination with one or more of the first through fourth aspects, the second set of one or more TAGs is configurable with a single TAG based at least in part on one or more of the single TAG of the second set of one or more TAGs being a different TAG from each TAG of the first set of multiple TAGs, or the first component carrier and the second component carrier being in different frequency bands.

In a sixth aspect, alone or in combination with one or more of the first through fifth aspects, transmission of the one or more communications via the first component carrier and the second component carrier comprises transmitting the one or more communications using inter-band carrier aggregation via the first component carrier and the second component carrier.

In a seventh aspect, alone or in combination with one or more of the first through sixth aspects, process 1000 includes receiving configuration information that indicates whether the second set of one or more TAGS is configurable with a single TAG based at least in part on one or more of the single TAG of the second set of one or more TAGs being a different TAG from each TAG of the first set of multiple TAGs, or the first component carrier and the second component carrier being in different frequency bands.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with configuring TA Gs for component carriers.

As shown in FIG. 11, in some aspects, process 1100 may include transmitting an indication of a capability to communicate with multiple TAs for a single component carrier (block 1110). For example, the UE (e.g., using communication manager 140 and/or transmission component 1404, depicted in FIG. 14) may transmit an indication of a capability to communicate with multiple TAs for a single component carrier, as described above.

As further shown in FIG. 11, in some aspects, process 1100 may include receiving configuration information indicating: multiple CORESET pool indexes for communication within the single component carrier, and one or more TAGS for the single component carrier based at least in part on the capability (block 1120). For example, the UE (e.g., using communication manager 140 and/or reception component 1402, depicted in FIG. 14) may receive configuration information indicating: multiple CORESET pool indexes for communication within the single component carrier, and one or more TAGS for the single component carrier based at least in part on the capability, as described above.

Process 1100 may include additional aspects, such as any single aspect or any combination of aspects described below and/or in connection with one or more other processes described elsewhere herein.

In a first aspect, the configuration information indicates multiple TAGs for the single component carrier based at least in part on the capability supporting multiple TAGs for the single component carrier.

In a second aspect, alone or in combination with the first aspect, the configuration information indicates multiple TAGs for the single component carrier based further in part on the multiple CORESET pool indexes being associated with different propagation times to one or more network nodes.

In a third aspect, alone or in combination with one or more of the first and second aspects, the configuration information indicates a single TAG for the single component carrier based at least in part on the multiple CORESET pool indexes being associated with propagation times that differ by an amount that satisfies a threshold.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., a base station 110, a CU, a DU, and/or a CU) performs operations associated with configuring TAGs for component carriers.

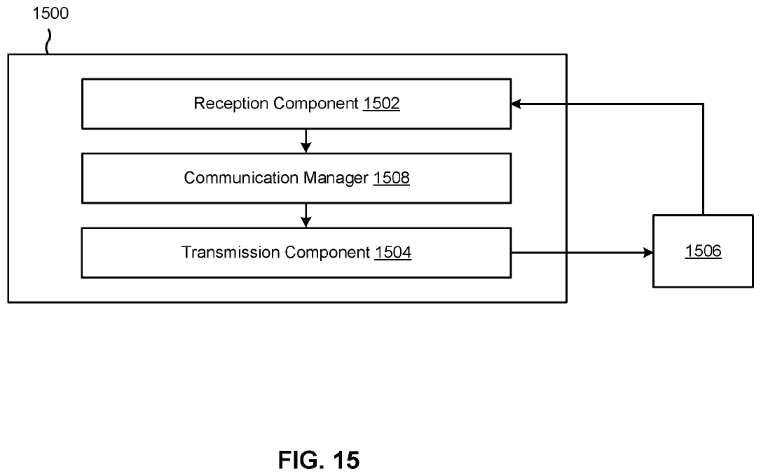

As shown in FIG. 12, in some aspects, process 1200 may include transmitting configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs (block 1210). For example, the network node (e.g., using communication manager 150 and/or transmission component 1504, depicted in FIG. 15) may transmit configuration information indicating: a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs, as described above.

As further shown in FIG. 12, in some aspects, process 1200 may include receiving one or more communications via the first component carrier and the second component carrier based at least in part the first set of multiple TAGs and the second set of one or more TAGS (block 1220). For example, the network node (e.g., using communication manager 150 and/or reception component 1502, depicted in FIG. 15) may receive one or more communications via the first component carrier and the second component carrier based at least in part the first set of multiple TAGs and the second set of one or more TAGS, as described above.

Process 1200 may include additional aspects, such as any single aspect or any combination of aspects described below and/or in connection with one or more other processes described elsewhere herein.

In a first aspect, the second set of one or more TAGs is configured with a same number of TAGs as the first set of multiple TAGs.

In a second aspect, alone or in combination with the first aspect, the second set of one or more TAGs is configured with multiple TAGs based at least in part on the first set of multiple TAGs being configured with multiple TAGs.

In a third aspect, alone or in combination with one or more of the first and second aspects, the second set of one or more TAGs is configured based at least in part on the first set of multiple TAGs based at least in part on the first component carrier being configured with multiple CORESET pool indexes, and the second component carrier being configured with multiple CORESET pool indexes.

In a fourth aspect, alone or in combination with one or more of the first through third aspects, the second component carrier is configurable with multiple CORESET pool indexes based at least in part on the second set of one or more TAGS being configured with multiple TAGs.

In a fifth aspect, alone or in combination with one or more of the first through fourth aspects, the second set of one or more TAGS is configurable with a single TAG based at least in part on one or more of the single TAG of the second set of one or more TAGs being a different TAG from each TAG of the first set of multiple TAGs, or the first component carrier and the second component carrier being in different frequency bands.

In a sixth aspect, alone or in combination with one or more of the first through fifth aspects, reception of the one or more communications via the first component carrier and the second component carrier comprises receiving the one or more communications using inter-band carrier aggregation via the first component carrier and the second component carrier.

In a seventh aspect, alone or in combination with one or more of the first through sixth aspects, process 1200 includes transmitting configuration information that indicates whether the second set of one or more TAGs is configurable with a single TAG based at least in part on one or more of the single TAG of the second set of one or more TAGs being a different TAG from each TAG of the first set of multiple TAGs, or the first component carrier and the second component carrier being in different frequency bands.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., a base station 110, a CU, a DU, and/or a CU) performs operations associated with configuring TAGs for component carriers.

As shown in FIG. 13, in some aspects, process 1300 may include receiving an indication of a capability to communicate with multiple TAs for a single component carrier (block 1310). For example, the network node (e.g., using communication manager 150 and/or reception component 1502, depicted in FIG. 15) may receive an indication of a capability to communicate with multiple TAs for a single component carrier, as described above.

As further shown in FIG. 13, in some aspects, process 1300 may include transmitting configuration information indicating: multiple CORESET pool indexes for communication within the single component carrier, and one or more TAGS for the single component carrier based at least in part on the capability (block 1320). For example, the network node (e.g., using communication manager 150 and/or transmission component 1504, depicted in FIG. 15) may transmit configuration information indicating: multiple CORESET pool indexes for communication within the single component carrier, and one or more TAGS for the single component carrier based at least in part on the capability, as described above.

Process 1300 may include additional aspects, such as any single aspect or any combination of aspects described below and/or in connection with one or more other processes described elsewhere herein.

In a first aspect, the configuration information indicates multiple TAGs for the single component carrier based at least in part on the capability supporting multiple TAGs for the single component carrier.

In a second aspect, alone or in combination with the first aspect, the configuration information indicates multiple TAGs for the single component carrier based further in part on the multiple CORESET pool indexes being associated with different propagation times to one or more network nodes.

In a third aspect, alone or in combination with one or more of the first and second aspects, the configuration information indicates a single TAG for the single component carrier based at least in part on the multiple CORESET pool indexes being associated with propagation times that differ by an amount that satisfies a threshold.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

The foregoing disclosure provides illustration and description but is not intended to be exhaustive or to limit the aspects to the precise forms disclosed. Modifications and variations may be made in light of the above disclosure or may be acquired from practice of the aspects.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1408 (e.g., the communication manager 140.)

In some aspects, the apparatus 1400 may be configured to perform one or more operations described herein in connection with FIG. 9. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive configuration information indicating a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs. The transmission component 1404 may transmit one or more communications via the first component carrier and the second component carrier based at least in part the first set of multiple TAGs and the second set of one or more TAGS.

The reception component 1402 may receive configuration information that indicates whether the second set of one or more TAGs is configurable with a single TAG based at least in part on one or more of the single TAG of the second set of one or more TAGs being a different TAG from each TAG of the first set of multiple TAGs, or the first component carrier and the second component carrier being in different frequency bands.

The transmission component 1404 may transmit an indication of a capability to communicate with multiple TAs for a single component carrier. The reception component 1402 may receive configuration information indicating multiple CORESET pool indexes for communication within the single component carrier, and one or more TAGs for the single component carrier based at least in part on the capability.

The communication manager 1408 may provide information to and/or receive information from the reception component 1402 and/or the transmission component 1404 in connection with one or more operations of the reception component 1402 and/or the transmission component 1404.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a communication manager 1508 (e.g., the communication manager 150).

In some aspects, the apparatus 1500 may be configured to perform one or more operations described herein in connection with FIG. 9. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit configuration information indicating a first configuration of multiple CORESET pool indexes for a first component carrier and for a second component carrier, and a second configuration of a first set of multiple TAGs for the first component carrier and a second set of one or more TAGS for the second component carrier, wherein the second set of one or more TAGs is configured based at least in part the first set of multiple TAGs. The reception component 1502 may receive one or more communications via the first component carrier and the second component carrier based at least in part the first set of multiple TAGs and the second set of one or more TAGS.

The transmission component 1504 may transmit configuration information that indicates whether the second set of one or more TAGs is configurable with a single TAG based at least in part on one or more of the single TAG of the second set of one or more TAGs being a different TAG from each TAG of the first set of multiple TAGs, or the first component carrier and the second component carrier being in different frequency bands.

The reception component 1502 may receive an indication of a capability to communicate with multiple TAs for a single component carrier. The transmission component 1504 may transmit configuration information indicating multiple CORESET pool indexes for communication within the single component carrier, and one or more TAGs for the single component carrier based at least in part on the capability.

The communication manager 1508 may provide information to and/or receive information from the reception component 1502 and/or the transmission component 1504 in connection with one or more operations of the reception component 1502 and/or the transmission component 1504.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving configuration information indicating: a first configuration of multiple control resource set (CORESET) pool indexes for a first component carrier and for a second component carrier, and a second configuration of a first set of multiple timing advance groups (TAGs) for the first component carrier and a second set of one or more TAGS for the second component carrier, wherein the second set of one or more TAGs is configured based at least in part the first set of multiple TAGs; and transmitting one or more communications via the first component carrier and the second component carrier based at least in part the first set of multiple TAGs and the second set of one or more TAGS.

Aspect 2: The method of Aspect 1, wherein the second set of one or more TAGs is configured with a same number of TAGs as the first set of multiple TAGs.

Aspect 3: The method of any of Aspects 1-2, wherein the second set of one or more TAGS is configured with multiple TAGs based at least in part on the first set of multiple TAGs being configured with multiple TAGs.

Aspect 4: The method of any of Aspects 1-3, wherein the second set of one or more TAGS is configured based at least in part on the first set of multiple TAGs based at least in part on: the first component carrier being configured with multiple CORESET pool indexes, and the second component carrier being configured with multiple CORESET pool indexes.

Aspect 5: The method of any of Aspects 1-4, wherein the second component carrier is configurable with multiple CORESET pool indexes based at least in part on the second set of one or more TAGs being configured with multiple TAGs.

Aspect 6: The method of any of Aspects 1-5, wherein the second set of one or more TAGs is configurable with a single TAG based at least in part on one or more of: the single TAG of the second set of one or more TAGs being a different TAG from each TAG of the first set of multiple TAGs, or the first component carrier and the second component carrier being in different frequency bands.

Aspect 7: The method of Aspect 6, wherein transmission of the one or more communications via the first component carrier and the second component carrier comprises: transmitting the one or more communications using inter-band carrier aggregation via the first component carrier and the second component carrier.

Aspect 8: The method of any of Aspects 1-7, further comprising: receiving configuration information that indicates whether the second set of one or more TAGS is configurable with a single TAG based at least in part on one or more of: the single TAG of the second set of one or more TAGS being a different TAG from each TAG of the first set of multiple TAGs, or the first component carrier and the second component carrier being in different frequency bands.

Aspect 9: A method of wireless communication performed by a user equipment (UE), comprising: transmitting an indication of a capability to communicate with multiple timing advances (TAs) for a single component carrier; and receiving configuration information indicating: multiple control resource set (CORESET) pool indexes for communication within the single component carrier, and one or more timing advance groups (TAGs) for the single component carrier based at least in part on the capability.

Aspect 10: The method of Aspect 9, wherein the configuration information indicates multiple TAGs for the single component carrier based at least in part on the capability supporting multiple TAGs for the single component carrier.

Aspect 11: The method of Aspect 10, wherein the configuration information indicates multiple TAGs for the single component carrier based further in part on the multiple CORESET pool indexes being associated with different propagation times to one or more network nodes.

Aspect 12: The method of any of Aspects 9-11, wherein the configuration information indicates a single TAG for the single component carrier based at least in part on the multiple CORESET pool indexes being associated with propagation times that differ by an amount that satisfies a threshold.

Aspect 13: A method of wireless communication performed by a network node, comprising: transmitting configuration information indicating: a first configuration of multiple control resource set (CORESET) pool indexes for a first component carrier and for a second component carrier, and a second configuration of a first set of multiple timing advance groups (TAGs) for the first component carrier and a second set of one or more TAGS for the second component carrier, wherein the second set of one or more TAGs is configured based at least in part the first set of multiple TAGS; and receiving one or more communications via the first component carrier and the second component carrier based at least in part the first set of multiple TAGs and the second set of one or more TAGs.

Aspect 14: The method of Aspect 13, wherein the second set of one or more TAGs is configured with a same number of TAGs as the first set of multiple TAGs.

Aspect 15: The method of any of Aspects 13-14, wherein the second set of one or more TAGs is configured with multiple TAGs based at least in part on the first set of multiple TAGs being configured with multiple TAGs.

Aspect 16: The method of any of Aspects 13-15, wherein the second set of one or more TAGs is configured based at least in part on the first set of multiple TAGs based at least in part on: the first component carrier being configured with multiple CORESET pool indexes, and the second component carrier being configured with multiple CORESET pool indexes.

Aspect 17: The method of any of Aspects 13-16, wherein the second component carrier is configurable with multiple CORESET pool indexes based at least in part on the second set of one or more TAGs being configured with multiple TAGs.

Aspect 18: The method of any of Aspects 13-17, wherein the second set of one or more TAGs is configurable with a single TAG based at least in part on one or more of: the single TAG of the second set of one or more TAGs being a different TAG from each TAG of the first set of multiple TAGs, or the first component carrier and the second component carrier being in different frequency bands.

Aspect 19: The method of Aspect 18, wherein reception of the one or more communications via the first component carrier and the second component carrier comprises: receiving the one or more communications using inter-band carrier aggregation via the first component carrier and the second component carrier.

Aspect 20: The method of any of Aspects 13-19, further comprising: transmitting configuration information that indicates whether the second set of one or more TAGs is configurable with a single TAG based at least in part on one or more of: the single TAG of the second set of one or more TAGs being a different TAG from each TAG of the first set of multiple TAGs, or the first component carrier and the second component carrier being in different frequency bands.

Aspect 21: A method of wireless communication performed by a network node, comprising: receiving an indication of a capability to communicate with multiple timing advances (TAs) for a single component carrier; and transmitting configuration information indicating: multiple control resource set (CORESET) pool indexes for communication within the single component carrier, and one or more timing advance groups (TAGs) for the single component carrier based at least in part on the capability.

Aspect 22: The method of Aspect 21, wherein the configuration information indicates multiple TAGs for the single component carrier based at least in part on the capability supporting multiple TAGs for the single component carrier.

Aspect 23: The method of Aspect 22, wherein the configuration information indicates multiple TAGs for the single component carrier based further in part on the multiple CORESET pool indexes being associated with different propagation times to one or more network nodes.

Aspect 24: The method of any of Aspects 21-23, wherein the configuration information indicates a single TAG for the single component carrier based at least in part on the multiple CORESET pool indexes being associated with propagation times that differ by an amount that satisfies a threshold.

Aspect 25: An apparatus for wireless communication at a device, comprising a processor: memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving configuration information indicating:
a first configuration of multiple control resource set (CORESET) pool indexes for a first component carrier and for a second component carrier, and
a second configuration of a first set of multiple timing advance groups (TAGs) for the first component carrier and a second set of one or more TAGS for the second component carrier, wherein the second set of one or more TAGs is configured based at least in part the first set of multiple TAGs; and
transmitting one or more communications via the first component carrier and the second component carrier based at least in part the first set of multiple TAGs and the second set of one or more TAGS.

2. The method of claim 1, wherein the second set of one or more TAGS is configured with a same number of TAGs as the first set of multiple TAGs.

3. The method of claim 1, wherein the second set of one or more TAGS is configured with multiple TAGs based at least in part on the first set of multiple TAGs being configured with multiple TAGs.

4. The method of claim 1, wherein the second set of one or more TAGS is configured based at least in part on the first set of multiple TAGs based at least in part on:
the first component carrier being configured with multiple CORESET pool indexes, and
the second component carrier being configured with multiple CORESET pool indexes.

5. The method of claim 1, wherein the second component carrier is configurable with multiple CORESET pool indexes based at least in part on the second set of one or more TAGs being configured with multiple TAGs.

6. The method of claim 1, wherein the second set of one or more TAGS is configurable with a single TAG based at least in part on one or more of:
the single TAG of the second set of one or more TAGs being a different TAG from each TAG of the first set of multiple TAGs, or
the first component carrier and the second component carrier being in different frequency bands.

7. The method of claim 6, wherein transmission of the one or more communications via the first component carrier and the second component carrier comprises:
transmitting the one or more communications using inter-band carrier aggregation via the first component carrier and the second component carrier.

8. The method of claim 1, further comprising:
receiving configuration information that indicates whether the second set of one or more TAGs is configurable with a single TAG based at least in part on one or more of:
the single TAG of the second set of one or more TAGs being a different TAG from each TAG of the first set of multiple TAGs, or
the first component carrier and the second component carrier being in different frequency bands.

9. A method of wireless communication performed by a user equipment (UE), comprising:
transmitting an indication of a capability to communicate with multiple timing advances (TAs) for a single component carrier; and
receiving configuration information indicating:
multiple control resource set (CORESET) pool indexes for communication within the single component carrier, and
one or more timing advance groups (TAGs) for the single component carrier based at least in part on the capability.

10. The method of claim 9, wherein the configuration information indicates multiple TAGs for the single component carrier based at least in part on the capability supporting multiple TAGs for the single component carrier.

11. The method of claim 10, wherein the configuration information indicates multiple TAGs for the single component carrier based further in part on the multiple CORESET pool indexes being associated with different propagation times to one or more network nodes.

12. The method of claim 9, wherein the configuration information indicates a single TAG for the single component carrier based at least in part on the multiple CORESET pool indexes being associated with propagation times that differ by an amount that satisfies a threshold.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A user equipment (UE) for wireless communication, comprising:
a memory; and
one or more processors, coupled to the memory, configured to:
receive configuration information indicating:
a first configuration of multiple control resource set (CORESET) pool indexes for a first component carrier and for a second component carrier, and
a second configuration of a first set of multiple timing advance groups (TAGs) for the first component carrier and a second set of one or more TAGS for the second component carrier, wherein the second set of one or more TAGS is configured based at least in part the first set of multiple TAGs; and
transmit one or more communications via the first component carrier and the second component carrier based at least in part the first set of multiple TAGs and the second set of one or more TAGS.

26. The UE of claim 25, wherein the second set of one or more TAGS is configured with a same number of TAGs as the first set of multiple TAGs.

27. The UE of claim 25, wherein the second set of one or more TAGS is configured with multiple TAGs based at least in part on the first set of multiple TAGs being configured with multiple TAGs.

28. The UE of claim 25, wherein the second set of one or more TAGS is configured based at least in part on the first set of multiple TAGs based at least in part on:
the first component carrier being configured with multiple CORESET pool indexes, and
the second component carrier being configured with multiple CORESET pool indexes.

29. The UE of claim 25, wherein the second component carrier is configurable with multiple CORESET pool indexes based at least in part on the second set of one or more TAGs being configured with multiple TAGs.

30. The UE of claim 25, wherein the second set of one or more TAGS is configurable with a single TAG based at least in part on one or more of:
the single TAG of the second set of one or more TAGs being a different TAG from each TAG of the first set of multiple TAGs, or
the first component carrier and the second component carrier being in different frequency bands.

31. The UE of claim 30, wherein transmission of the one or more communications via the first component carrier and the second component carrier comprises:
transmission of the one or more communications using inter-band carrier aggregation via the first component carrier and the second component carrier.

32. The UE of claim 25, wherein the one or more processors are further configured to:
receive configuration information that indicates whether the second set of one or more TAGs is configurable with a single TAG based at least in part on one or more of:
the single TAG of the second set of one or more TAGS being a different TAG from each TAG of the first set of multiple TAGs, or
the first component carrier and the second component carrier being in different frequency bands.

33. A UE for wireless communication, comprising:
a memory; and
one or more processors, coupled to the memory, configured to:
transmit an indication of a capability to communicate with multiple timing advances (TAs) for a single component carrier; and
receive configuration information indicating:
multiple control resource set (CORESET) pool indexes for communication within the single component carrier, and
one or more timing advance groups (TAGs) for the single component carrier based at least in part on the capability.

34. The UE of claim 33, wherein the configuration information indicates multiple TAGs for the single component carrier based at least in part on the capability supporting multiple TAGs for the single component carrier.

35. The UE of claim 34, wherein the configuration information indicates multiple TAGs for the single component carrier based further in part on the multiple CORESET pool indexes being associated with different propagation times to one or more network nodes.

36. The UE of claim 33, wherein the configuration information indicates a single TAG for the single component carrier based at least in part on the multiple CORESET pool indexes being associated with propagation times that differ by an amount that satisfies a threshold.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)
